(19) United States
(12) Patent Application Publication
(10) Pub. No.: US 2008/0222316 A1
(43) Pub. Date: Sep. 11, 2008

(54) Communication system, communication method, and communication device

(76) Inventor: Yasuhiro Sato, Kanagawa (JP)

Correspondence Address: DICKSTEIN SHAPIRO LLP, 1825 EYE STREET NW, Washington, DC, 20006-5403, US

(21) Appl. No.: 12/004,407

(22) Filed: Dec. 21, 2007

(30) Foreign Application Priority Data
Mar. 7, 2007 (JP) 2007-057885

(51) Int. Cl. G06F 13/10; G06F 13/14

(52) U.S. Cl. 710/16; 710/31

(57) ABSTRACT

A disclosed communication system, communication method, and communication device enable an intended command to be easily acquired from a movement of an operator and executed. The communication system includes a first communication device and a second communication device communicating with each other. The first communication device includes a physical quantity detection unit that detects a physical quantity that changes as the first communication device moves. Based on an increase or a decrease in the physical quantity detected by the physical quantity detection unit, a communication direction is determined by a direction determination unit of the first communication device. Based on the thus determined communication direction, a communication unit of the first communication device communicates with the second communication device.

### BACKGROUND OF THE INVENTION

1. Field of the Invention

The present invention relates to communication systems, communication methods, and communication devices.

2. Description of the Related Art

Information processing apparatuses are known by which human movements are acquired as commands and responses are performed. For example, Japanese Laid-Open Patent Application No. 7-175587 discloses an invention of an information processing apparatus whereby an operator's hand movements are interpreted based on images provided by an imaging device, and an operation associated with an interpretation of the intention of the operator is performed.

The information processing apparatus disclosed in the above publication involves image analysis. However, image analysis generally requires a great deal of resources in equipment, time, etc., and is sometimes not suitable for implementation in small-sized devices. Particularly, in the case of wireless communication devices touting portability, an imaging unit located away from an operator is not realistic.

### SUMMARY OF THE INVENTION

It is therefore a general object of the present invention to overcome the above problems of the related art.

A more specific object of the invention is to provide a communication system, a communication method, and a communication device whereby a command intended to be sent by an operator can be readily acquired and acted upon based on information relating to, e.g., the displacement of the operator's communication device.

In one aspect, the invention provides a communication system comprising a first communication device and a second communication device that communicate with each other. The first communication device comprises a physical quantity detection unit configured to detect a physical quantity that changes as the first communication device moves; a direction determination unit configured to determine a communication direction between the first and second communication devices in accordance with a change in the physical quantity detected by the physical quantity detection unit; and a communication unit configured to communicate with the second communication device based on the communication direction that is determined by the direction determination unit.

Preferably, the second communication device may comprise a physical quantity detection slave unit corresponding to the physical quantity detection unit. The physical quantity detection unit is configured to detect the physical quantity in cooperation with the physical quantity detection slave unit.

Preferably, the direction determination unit may be configured to determine a communication direction based on the change in the physical quantity detected by the physical quantity detection unit exceeding a predetermined value.

Thus, a communication system can be provided in which a command intended by the operator can be easily acquired from information indicating, e.g., the displacement of a communication device by the operator.

Preferably, the first communication device may comprise a mode selection unit configured to select a data transmission/reception mode. The direction determination unit is configured to determine a communication direction based on the change in the physical quantity upon selection of the data transmission/reception mode.

Thus, the operator's intention can be ascertained in a more preferable manner by selecting a data transmission/reception mode.

Preferably, the first communication device comprises a distance measuring unit configured to measure the distance from the second communication device. The communication unit is configured to communicate with one of plural different candidates for the second communication device that has the shortest distance from the first communication device.

Thus, one of plural communication device candidates for the second communication device can be selected based on the distances from the first communication device.

Preferably, the first communication device may comprise an opposed angle measuring unit configured to measure an opposed angle of the second communication device relative to the first communication device. The communication unit is configured to communicate with one of plural different candidates for the second communication device that has the smallest opposed angle.

Thus, one of plural communication device candidates for the second communication device can be selected based on the opposed angles.

Preferably, the first communication device may comprise a screen generation unit configured to generate a screen for displaying information about the functions of the second communication device; and a function selection unit configured to select one of the functions of the second communication device. The second communication device is configured to transmit data received from the first communication device in accordance with a function selected by the function selection unit, or to transmit received data to the first communication device in accordance with a function selected by the function selection unit.

Thus, a command concerning a function of the second communication device can be acquired based on the movement of the operator and then the function can be implemented.

Preferably, the first communication device may comprise a candidate information acquisition unit configured to acquire information about candidates for the second communication device; and a candidate screen generation unit configured to generate a screen for displaying information about the candidates for the second communication device.

Thus, a second communication device with which the operator wishes to communicate can be selected from plural different communication device candidates.

Preferably, the direction determination unit may be configured to determine a communication direction for transmission when the change in the physical quantity indicates that the distance between the communication device and the other communication device is becoming smaller, and a communication direction for reception when the change in the physical quantity indicates that the distance between the communication device and the other communication device is becoming larger.

Thus, the direction of movement of an operator's communication device can be aligned with the direction of communication, whereby the operator's intended command can be acquired intuitively.

In another aspect, the invention provides a communication method that implements the functions of the individual units of the communication devices in the above communication system. In yet another aspect, the invention provides a computer-readable program for causing a computer to carry out the communication method. In another aspect, the invention also provides a communication device adapted for the above communication system.

In accordance with the present invention, an intended command can be easily acquired from a movement of the operator and then executed.

### BRIEF DESCRIPTION OF THE DRAWINGS

FIG. 1 is a drawing for the explanation of the FTAM (File Transfer, Access, and Management) protocol in the application layer of the OSI (Open Systems Interconnection) reference model;

FIG. 2 shows an example of the functional configuration of a communication system according to an embodiment of the present invention;

FIG. 3 shows a communication system in which a communication direction is determined based on a change in distance;

FIG. 4A shows an example of a process of determining a communication direction based on a change in distance;

FIG. 4B shows how the distance between a first communication device and a second communication device changes over time;

FIG. 4C shows how the velocity of the first communication device changes over time;

FIG. 5A shows another example of the process of determining a communication direction based on a change in distance;

FIG. 5B shows how the distance between a first communication device and a second communication device changes over time;

FIG. 5C shows how the velocity of the first communication device changes over time;

FIG. 6 shows a flowchart of an example of the process of determining a communication direction based on a change in distance;

FIG. 7 shows a flowchart of an example of the process of determining a communication direction based on velocity calculated from a change in distance;

FIG. 8A shows an example of a process of determining a communication direction based on a change in angle or angular velocity;

FIG. 8B shows how angular velocity changes over time;

FIG. 8C shows how an angle changes over time;

FIG. 9A shows another example of the process of determining a communication direction based on a change in angle or angular velocity;

FIG. 9B shows how angular velocity changes over time;

FIG. 9C shows how an angle changes over time;

FIG. 10 a flowchart of an example of the process of determining a communication direction based on a change in angular velocity;

FIG. 11A shows a communication system in which a communication direction is determined based on a change in acceleration;

FIG. 11B shows how a communication direction is determined when acceleration exceeds a first threshold;

FIG. 11C shows how a communication direction is determined when acceleration drops below a second threshold;

FIG. 12 shows a flowchart of an example of the process of determining a communication direction based on a change in acceleration;

FIG. 13 shows an example of a process of selecting and performing a function of a communication device 2;

FIG. 14 shows a flowchart of an example of the process of selecting a function of the communication device 2;

FIG. 15 shows an example of a process of selecting a communication device from plural different communication devices based on distance; and

FIG. 16 shows an example of a process of selecting a communication device from plural different communication devices based on opposed angle.

### DETAILED DESCRIPTION OF THE PREFERRED EMBODIMENTS

In the following, the present invention is described by way of embodiments with reference to the drawings.

### First Mode of Carrying out the Invention

(An example of a function realized by a communication system according to an embodiment of the present invention)

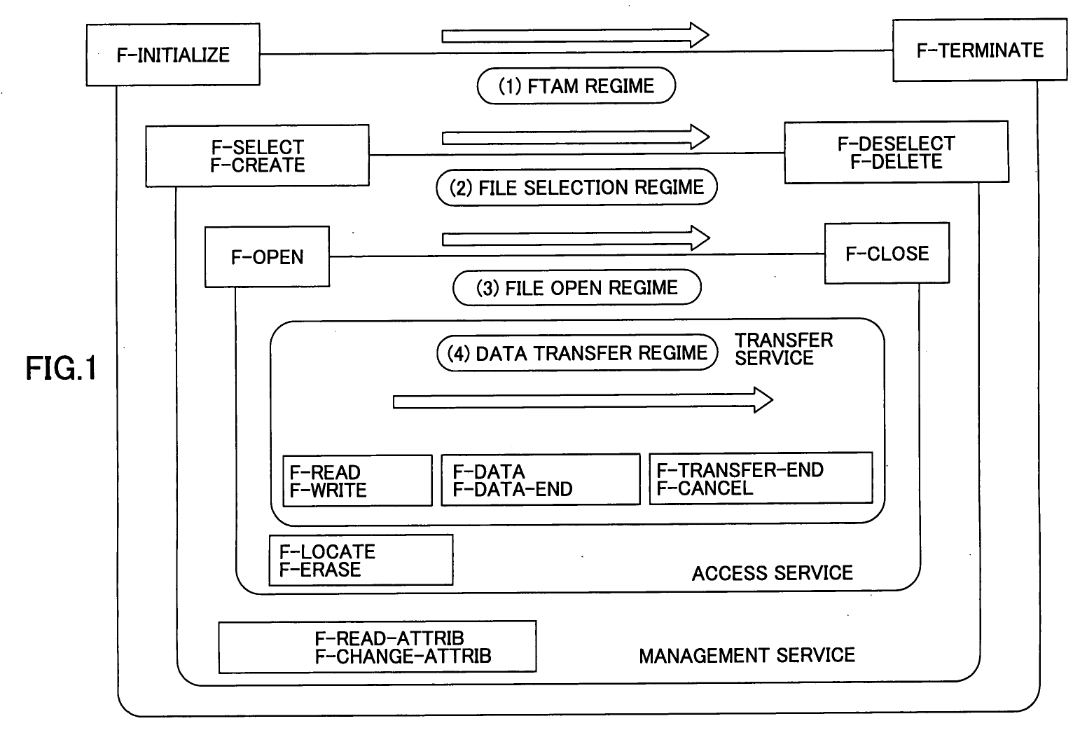

FIG. 1 illustrates the FTAM (File Transfer, Access and Management) protocol in the application layer of the OSI (Open Systems Interconnection) reference model proposed by the ISO. In FIG. 1, there are four FTAM regimes providing file services; namely, FTAM regime; file selection regime; file open regime; and data transfer regime.

In a communication system in accordance with an embodiment of the present invention, commands relating to file operations as shown in FIG. 1 are acquired by a physical quantity detection unit of a communication device and executed. However, this is merely an example; in another embodiment, a communication system of the present invention may be used for transmitting and receiving data for various purposes, such as mail transmission and reception, facsimile communications, and image formation.

(An example of the functional configuration of a communication system according to an embodiment of the present invention)

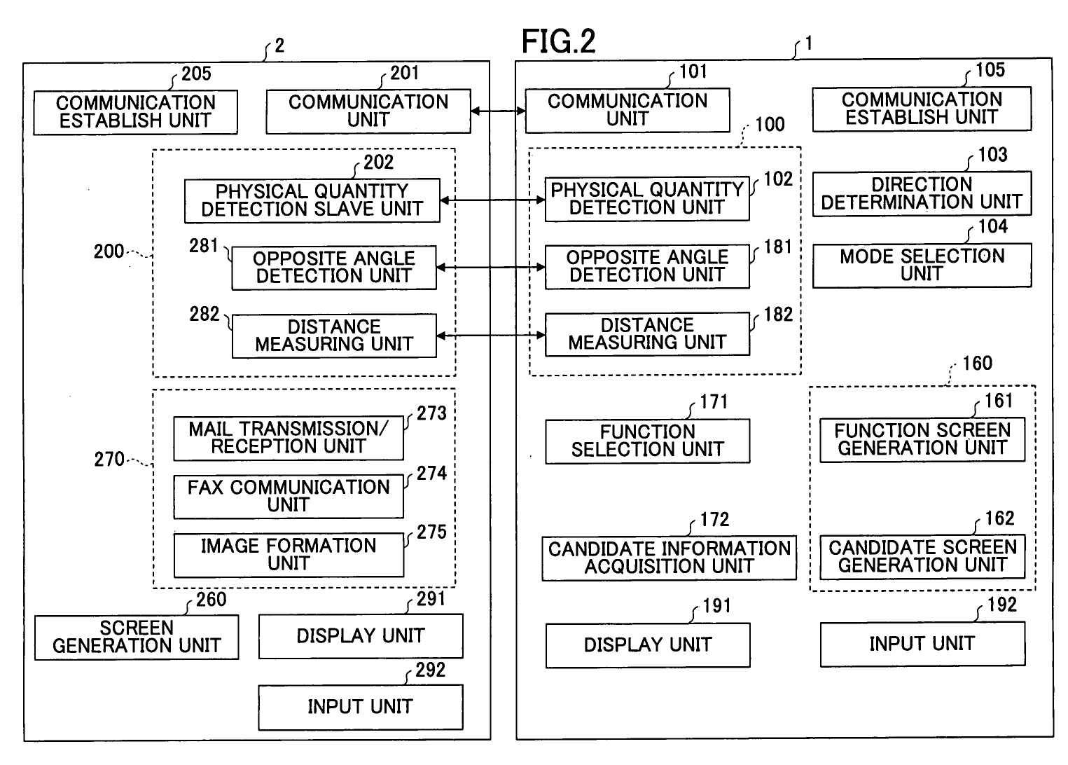

FIG. 2 shows the functional configuration of a communication system according to an embodiment of the present invention. In this communication system, data transmission or reception is performed after communications are established between a communication device 1 and a communication device 2.

The communication device 1 comprises a communication unit 101, a physical quantity detection unit 102, and a direction determination unit 103. The communication device 1 may further comprise a mode selection unit 104; a communication establishing unit 105; a screen generation unit 160; a function selection unit 171; a candidate information acquisition unit 172; an opposed angle detection unit 181; a distance measuring unit 182; a display unit 191; and an input unit 192.

The communication unit 101 is configured to communicate with the communication device 2. The communication unit 101 may be either a wireless communication unit or a wired communication unit. The physical quantity detection unit 102 detects a change in a physical quantity brought about by the movement of the communication device 1. The physical quantity detection unit 102 may comprise, e.g., a distance sensor, an acceleration sensor, or an angular velocity sensor.

The direction determination unit 103 determines a communication direction based on the change in the physical quantity detected by the physical quantity detection unit 102. The “communication direction” herein refers to either a transmitting direction or a receiving direction.

The mode selection unit 104 is configured to select an operation mode of the communication device 1. The operation modes of the communication device 1 include, e.g., a communication mode and an input mode. For example, as an operator designates the communication mode via the input unit 192 or the like, the communication mode is selected by the mode selection unit 104. Upon selection of the communication mode by the mode selection unit 104, a communication direction may be determined by the physical quantity detection unit 102 and the direction determination unit 103. In this way, the determination of the communication direction and the subsequent process for communications can be initiated upon designation of the communication mode by the operator, thus enabling the entry of a command that better reflects the operator's intention.

The communication establishing unit 105 is configured to establish communications with the communication device 2 or another communication device. The communication establishing unit 105 performs negotiations such as authentication. The communication establishing unit 105 may be configured to establish communications when a change in a physical quantity detected by the physical quantity detection unit 102 or the like meets predetermined conditions, for example.

The screen generation unit 160 is configured to generate various screens displayed by the display unit 191. The screen generation unit 160 includes a function screen generation unit 161 and a candidate screen generation unit 162. The function screen generation unit 161 generates a screen for displaying information associated with the functions of the communication device 2, such as the functions for mail transmission/reception, facsimile communication, and image formation. By displaying a list of such functions, an operator can select a desired function.

The candidate screen generation unit 162 generates a screen for displaying a list of communication device candidates from which one is to be selected for data transmission or reception. Alternatively, the candidate screen generation unit 162 may generate a screen for showing the positions of plural candidate communication devices relative to the communication device 1 when such position information is available.

The function selection unit 171 is configured to select one of the functions of the communication device 2. The function selection unit 171 may be configured to select a function designated by an operator via the input unit 192. Alternatively, the function selection unit 171 may be configured to select a function by analyzing information entered by the operator via the input unit 192. This means that, for example, if an analysis of information reveals that an entered character string contains “@,” the mail transmission function is selected assuming that that character string is a mail address. In another example, if an entered character string consists of about ten digits of numbers, the facsimile transmission function is selected assuming that these numbers represent a facsimile address.

The candidate information acquisition unit 172 is configured to acquire information about each of plural communication device candidates for communication. For example, the candidate information acquisition unit 172 acquires identifying information about communication devices, and information about their functions and locations. The candidate information acquisition unit 172 may be configured to acquire such information by communicating with the communication device candidates. Alternatively, such information may be acquired from a server in which information about communication device candidates are stored.

The opposed angle detection unit 181 is configured to measure an opposed angle of each communication device candidate relative to the communication device 1 when there are more than one communication device candidates. The opposed angle detection unit 181 comprises a geomagnetic sensor, for example.

The distance measuring unit 182 is configured to measure the distance from a counterpart communication device with which to communicate. For example, the distance measuring unit 182 measures the distance from a counterpart communication device by exchanging a predetermined signal. The distance measuring unit 182 may be configured in the form of a W-USB (Wireless USB) communication unit; in this case, the distance measuring unit 182 may be combined with the communication unit 101.

The opposed angle detection unit 181 or the distance measuring unit 182 may be used for detecting a physical quantity for determining a communication direction.

The display unit 191 is configured to display the status of the communication device 1, data processed by the communication device 1, etc. The input unit 192 is configured to allow the entry of an instruction and the like into the communication device 1 by an operator.

The communication device 2, which is configured to exchange data with the communication device 1, comprises a communication unit 201. It may further comprise a physical quantity detection slave unit 202; a communication establishing unit 205; a screen generation unit 260; a function realization unit 270; an opposed angle detection unit 281; a distance measuring unit 282; display unit 291; and an input unit 292.

The communication unit 201 is configured to communicate with the communication device 1 in a wired or wireless manner.

The physical quantity detection slave unit 202 is configured to detect a change in a physical quantity caused by the movement of the communication device 1, in cooperation with the physical quantity detection unit 102. For example, when detecting distance as a physical quantity, the physical quantity detection slave unit 202 exchanges a predetermined signal with the physical quantity detection unit 102 so as to enable the physical quantity detection unit 102 to detect the distance between the communication device 1 and the communication device 2.

In a case where the physical quantity detection unit 102 comprises an imaging unit, the physical quantity detection slave unit 202 may comprise a medium having a predetermined image, for example. In this case, the physical quantity detection unit 102 detects the distance between the communication device 1 and the communication device 2 based on information acquired by imaging the stored image and preset information saved in advance. The information about such preset image may be saved in a storage unit (not shown) of the communication device 1.

The communication establishing unit 205 is configured to establish communications with the communication device 1 or another communication device by performing negotiations, including authentication. The communication establishing unit 205 may be configured to establish communications when a change in a physical quantity detected by the physical quantity detection slave unit 202 or the like satisfies a predetermined condition.

The screen generation unit 260 is configured to generate a screen displayed on the display unit 291. For example, the screen generation unit 260 generates a screen for displaying an image read from a storage unit (not shown) of the communication device 2. The screen generation unit 260 may also be configured to generate a screen for displaying the functions of the communication device 2.

The function realization unit 270 is configured to realize the functions of the communication device 2 such as a mail transmission/reception function; a facsimile communication function; and an image forming function. The function realization unit 270 comprises a mail transmission/reception unit 273; a facsimile communication unit 274; and an image formation unit 275, for example.

The mail transmission/reception unit 273 performs mail transmission and reception by connecting to a mail server via the communication unit 201 or the like. The facsimile communication unit 274 performs the reception or transmission of a facsimile. The image formation unit 275 forms an image on a medium.

The opposed angle detection unit 281 is configured to detect an opposed angle between the communication device 1 and the communication device 2 in cooperation with the opposed angle detection unit 181 of the communication device 1. The opposed angle detection unit 281 comprises a geomagnetic sensor, for example.

The distance measuring unit 282 is configured to measure a distance from a communication device with which to communicate by exchanging a predetermined signal with the opposite communication device. The distance measuring unit 282 may comprise a W-USB (Wireless USB) communication unit; in this case, the distance measuring unit 282 may be incorporated into the communication unit 201.

The display unit 291 is configured to display an image of the status of the communication device 2, data processed by the communication device 2, etc. The input unit 292 is configured to enable an operator to enter instructions and the like into the communication device 2. The display unit 291 and the input unit 292 may be combined into a single device by sharing a touch panel.

### Embodiment 1

(A communication system in which a communication direction is determined based on a change in distance)

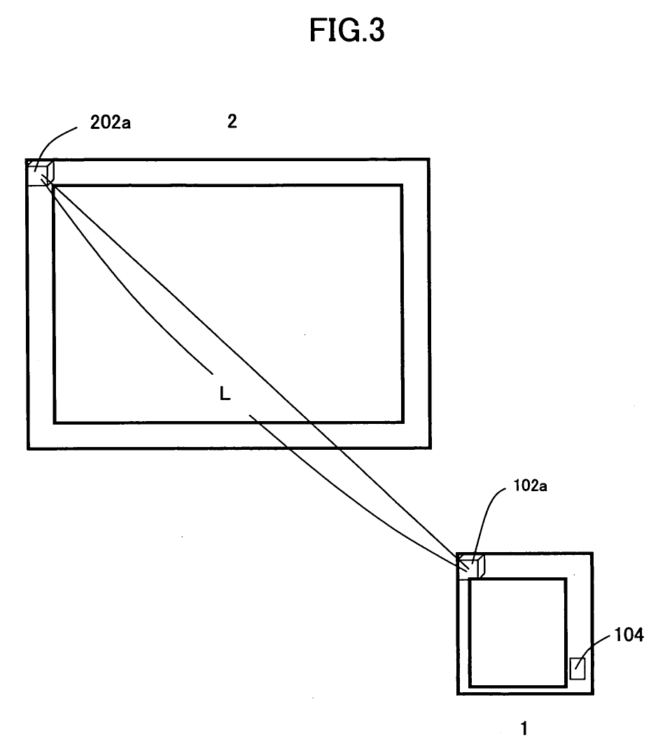

FIG. 3 shows a communication system configured to determine a communication direction by detecting a change in the distance between the communication device 1 and the communication device 2. While the embodiment shown in FIG. 3 comprises the two communication devices 1 and 2 each equipped with an image display function, they are merely examples; in another embodiment, a communication system may comprise copiers, printers, facsimiles, or multifunction peripherals having an LCD operating panel. “Multifunction peripherals” refers to those apparatuses combining various functions, such as a copier, printer, facsimile machine, mailer, and a server.

In the embodiment shown in FIG. 3, the communication device 1 and the communication device 2 each include a distance detection unit 202a, 102a for detecting the distance between the two communication devices as a physical quantity that changes as the communication device 1 moves. The distance detection units may comprise airborne ultrasound transmission/reception elements configured to measure the propagation time of airborne sound. Alternatively, they may employ infrared light and a PSD (Position Sensing Detector) to irradiate a certain location of a target device and measure an output voltage resulting from the infrared light reflected back to the PSD.

In an example of the method of measuring the propagation time of airborne sound, each device is equipped with a set of ultrasound transmission and reception elements. The transmission element in the communication device 1 is configured to transmit ultrasound of a particular frequency while a timer measures time. Simultaneously with the detection of the ultrasound by the reception element of the communication device 2, ultrasound of a particular frequency is transmitted back via the transmission element of the communication device 2. Upon detection of the return signal by the reception element communication device 1, the timer is stopped, and the measured time is considered the propagation time. The propagation time is then converted into distance by the equation V (m/s)=331.5+0.60714t (t: temperature (° C.)), which represents the general characteristics (propagation speed) of ultrasound. The transmission element and reception element may be combined in a single element having both transmission and reception functions.

The location of the distance detection unit is determined by the mode of use of each device or its mode of installation. When the communication device 2 is used in the form of a stationary image display device with a large screen size, or when the device is used as a message board, an operator may more often than not utilize the device facing its image display unit. Thus, it is desirable to install the distance detection unit 202a on the side of the display surface of the image display unit.

On the other hand, when the communication device 1 is in the form of, e.g., a PDA (Personal Digital Assistant) having an image display unit such as a liquid crystal display or an electronic paper, its operator may more often than not carry the device and view an image on its image display unit. The operator may also more often than not view the image display unit when communicating with a device from which the distance is to be detected. In this case, it is preferable to install the distance detection unit 102a on the side opposite the image display surface.

Various types of electronic paper, such as electrophoresis type, electrochromism type, thermal type, and colored particle rotation type, have been proposed as an image display device to replace the liquid crystal display. The viewing angle of electronic paper is closer to that of normal printed matter than the liquid crystal display. It also provides features such as low power consumption and memory function. For these reasons, electronic paper is expected to be increasingly used as an image display technology for portable terminals.

There is also the expectation that by integrating electronic circuits and sensors in electronic paper, there will be more opportunities to link electronic paper with other devices in the future. As devices become increasingly smaller, it becomes possible to provide a more natural and intuitive sense of operation by holding the electronic paper itself and gesturing, rather than by operating switches or manipulating a touch panel.

The communication device 2 and the communication device 1 may be located at different, visually spaced-apart locations, connected via a network. In such an operating environment, the communication device 2 may be operated via the network based on a change in a physical quantity caused by a movement of the communication device 1.

(Examples of the process of determining a communication direction based on a change in distance)

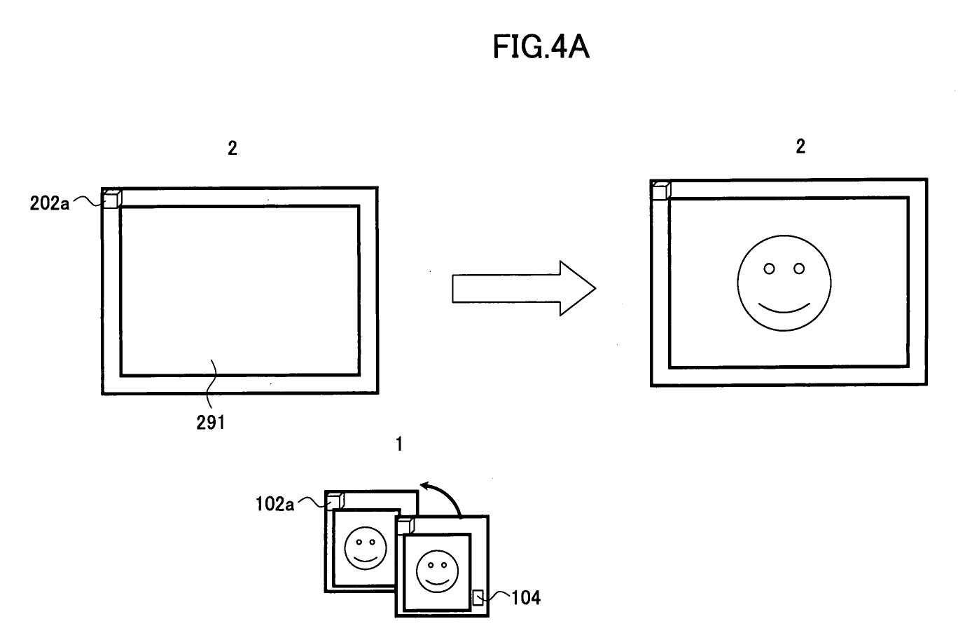

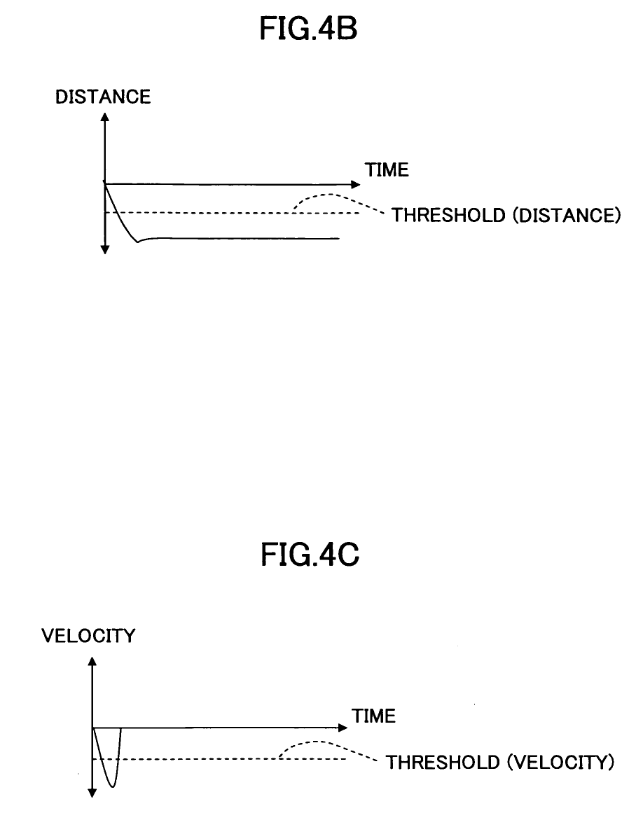

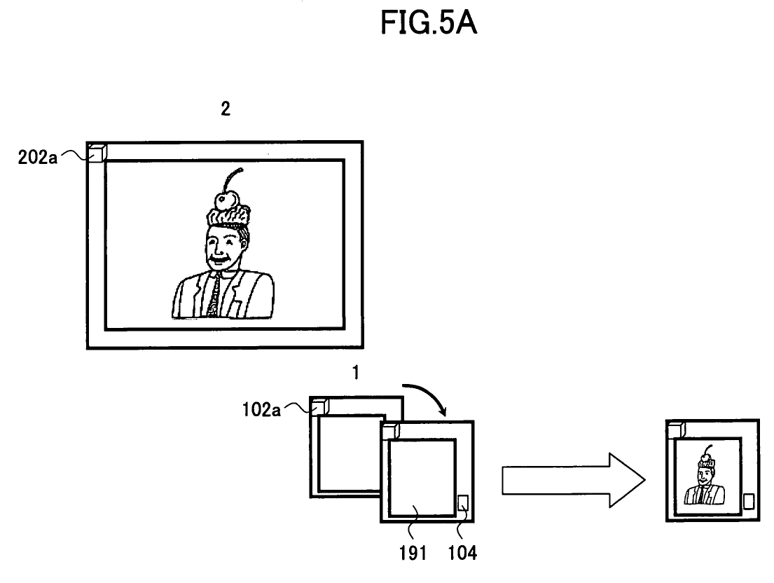

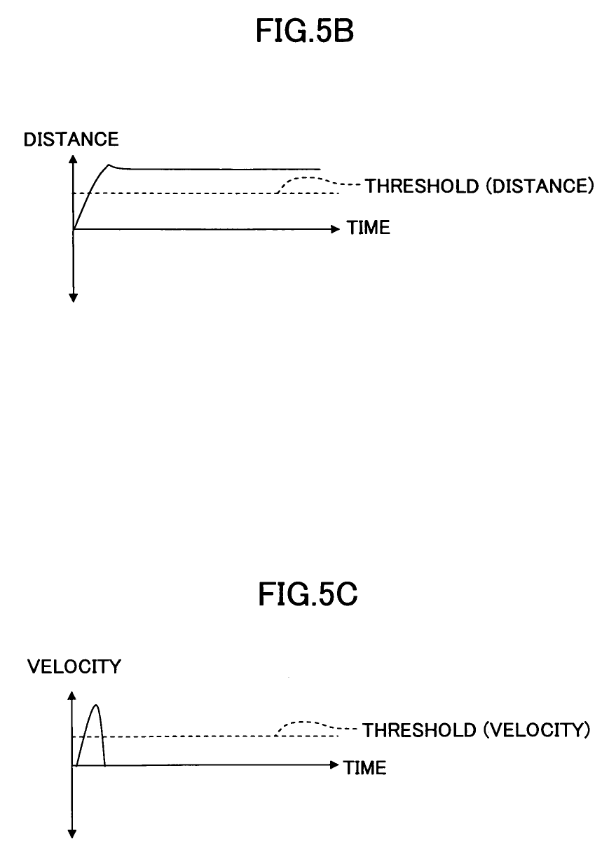

FIGS. 4A through 5C show examples of the process of determining a communication direction in the communication system of FIG. 3. In these examples, the communication device 1 is used in a working area such that the user of the communication device 1 can view a screen displayed by the display unit 291 of the communication device 2. This is the situation in a meeting, for example.

Referring to FIG. 4A, initially communication between the communication device 1 and the communication device 2 is established. The communications between the communication device 1 and the communication device 2 are conducted in accordance with a wired or wireless communication standard, such as, in the case of wireless communication, IEEE 801.11; IEEE 802.15.3a (UWB); IEEE 802.15.4 (Zigbee); Bluetooth(registered trademark); or Wireless USB.

With the communications between the communication device 1 and the communication device 2 having been established, an operator depresses a mode selection switch on the input unit 192 of the communication device 1. Thereby, a physical quantity detection mode is set, and the distance detection unit 102a becomes activated to detect the distance between the communication device 1 and the communication device 2.

Instead of the operator operating the mode switch, the communication device 1 may be provided with a motion detecting sensor, such as an acceleration sensor, so that the physical quantity detection mode can be automatically selected by a sensor signal provided by the sensor. For example, the ceasing of movement in the hand carrying the device could be assumed to show that the device is stably held by the operator based on an acceleration waveform, and then the mode can be automatically selected.

After the physical quantity detection mode is thus set, the operator moves the communication device 1 toward the communication device 2, as shown in FIG. 4A. When the distance between the communication device 1 and the communication device 2 detected by the distance detection unit has dropped below a first predetermined value as shown in FIG. 4B, the direction determination unit 103 determines a communication direction in which data are transmitted from the communication device 1 to the communication device 2. Thereafter, the communication unit 101 and the communication unit 201 perform data transmission and data reception in this communication direction.

In the example of FIG. 4A, an image displayed on the communication device 1 is transmitted to the communication device 2 and displayed on the display unit 291 of the communication device 2. However, the data that are transmitted or received are not limited to such image data; for example, they may be data created by Word (registered trademark of Microsoft Corp.), text editor data, or audio data.

Alternatively, as shown in FIG. 4C, the distance data obtained following the depressing of the mode selection switch may be differentiated with respect to time based on time measurement data provided by a timer (not shown) in the communication device 1 to calculate velocity. When the velocity has dropped below a first predetermined value, the direction determination unit 103 can determine that data should be transmitted from the communication device 1 to the communication device 2.

FIGS. 5A through 5C show a case in which the data communication direction is opposite from FIGS. 4A through 4C; namely, from the communication device 2 to the communication device 1. With the communications between the communication device 1 and the communication device 2 established, the operator depresses a mode selection switch, whereby the physical quantity detection mode is set and the distance detection unit 102a is activated to measure distance. The operator then moves the communication device 1 away from the communication device 2. When the resultant change in distance exceeds a second predetermined value as shown in FIG. 5B, the direction determination unit 103 determines a communication direction such that data are transmitted from the communication device 2 to the communication device 1. Thereafter, the communication unit 101 and the communication unit 102 perform data transmission and reception in accordance with this communication direction.

In the example of FIGS. 5A through 5C, an image displayed on the communication device 2 is transmitted to the communication device 1 and displayed on the display unit 190 of the communication device 1. However, the data transmitted and received are not limited to image data and may be various other kinds of data, such as text data and audio data.

Alternatively, as shown in FIG. 5C, the distance data obtained following the depressing of the mode selection switch may be differentiated with respect to time based on time measurement data provided by a timer (not shown) in the communication device 1 to calculate velocity. When the velocity has exceeded a predetermined value, the direction determination unit 103 can determine that data should be transmitted from the communication device 2 to the communication device 1.

(Flowchart of the process of determining a communication direction based on a change in distance)

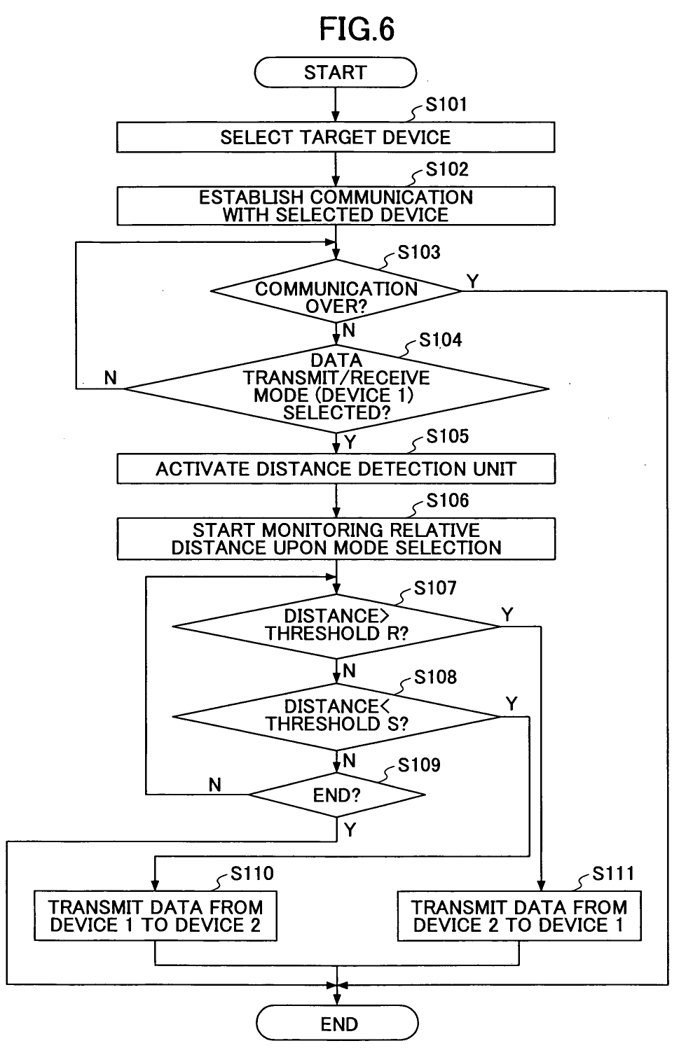

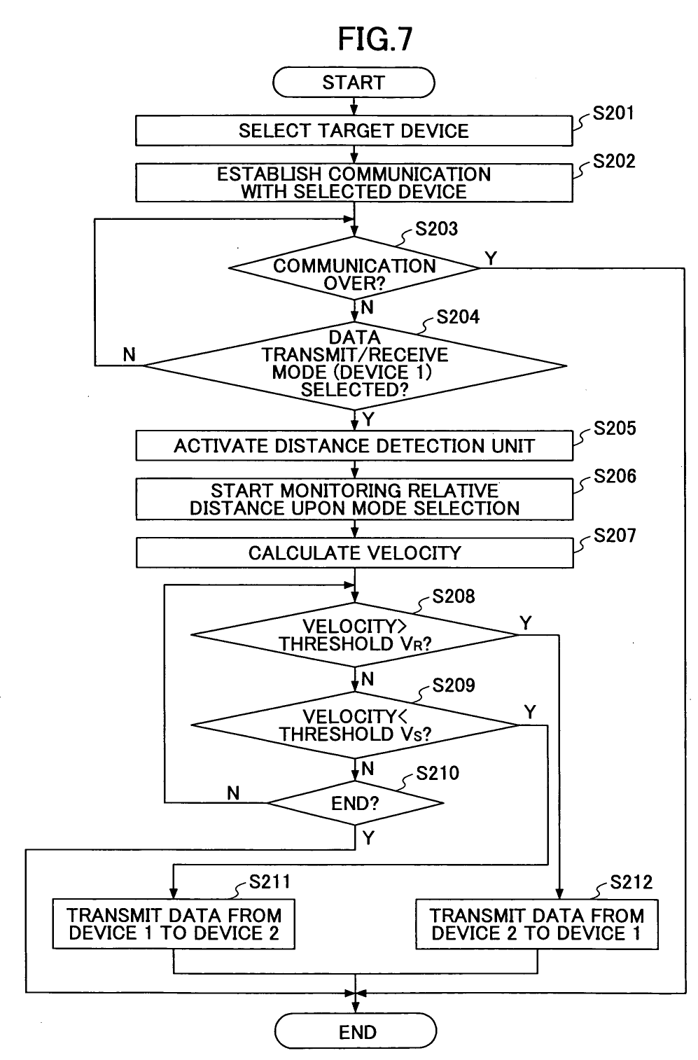

FIGS. 6 and 7 show flowcharts of examples of the process of determining a communication direction based on a change in the distance between the communication devices 1 and 2. FIG. 6 is an example in which distance is used as the parameter; FIG. 7 is an example in which velocity based on a change in distance is used as the parameter.

Referring to FIG. 6, in step S101, an operator selects a counterpart device via the input unit 192. The counterpart communication device may be selected by entering device identifying information, such as an IP address or MAC address, for example.

In step S102, communications between the selected communication device 2 and the communication device 1 are established by the communication establishing unit 105 and the communication establishing unit 205.

In step S103, it is determined whether data transmission/reception has been completed. If data transmission/reception has been completed, the communication unit 101 and the communication unit 201 perform a process to terminate communications. If not, the routine proceeds to step S104.

In step S104, it is determined whether a data transmission/reception mode has been set by the mode selection unit 104 in response to the operator depressing the mode selection switch. If the data transmission/reception mode has been selected, the routine proceeds to step S105; if not, the routine returns to step S103. Instead of the data transmission/reception mode, a mode for detecting a change in distance as a physical quantity may be selected.

In step S105, based on the setting of the data transmission/reception mode or the physical quantity detection mode in the mode selection unit 104, the distance detection unit 102a is activated. In step S106, the distance detection unit 102a, i.e., the physical quantity detection unit measures the distance between the communication device 1 and the communication device 2 in cooperation with the distance detection unit 202a, which is the physical quantity detection slave unit of the communication device 2. This measurement is continued for a predetermined period of time.

In step S107, the direction determination unit 103 determines whether the distance detected by the distance detection unit 102a has exceeded a predetermined value R. If the distance is greater than the value R, the routine proceeds to step S111; if not, the routine proceeds to step S108.

In step S108, the direction determination unit 103 determines whether the distance detected by the distance detection unit 102a is smaller than a predetermined value S. If the distance is smaller than the value S, the routine proceeds to step S110; if not, the routine proceeds to step S109.

In step S109, the mode selection unit 104 determines whether the data transmission/reception mode or the physical quantity detection mode should be terminated. If either mode should be terminated, the routine ends; if not, the routine returns to step S107. The decision as to whether the data transmission/reception mode or the physical quantity detection mode should be terminated may be made based on the entry of a mode cancelling instruction by the operator via the input unit 192. Alternatively, the decision may be based on the passage of a predetermined period of time following the selection of either mode.

In step S111, data are transmitted from the communication device 2 to the communication device 1 in accordance with the communication direction determined by the direction determination unit 103. On the other hand, in step S110 following step S108, data are transmitted from the communication device 1 to the communication device 2 in accordance with the communication direction determined by the direction determination unit 103.

Through these steps, the communication direction between the communication device 1 and the communication device 2 is determined based on a change in the distance between the communication device 1 and the communication device 2, and then data transmission/reception is performed.

FIG. 7 shows a flowchart of an example of the process of determining a communication direction by calculating velocity based on the distance detected as shown in FIG. 6. Steps S201 to S206 in FIG. 7 are identical to steps S101 to S106 in FIG. 6; therefore, their description is omitted.

In step S207, the distance detected by the physical quantity detection unit, i.e., the distance detection unit 102a, is differentiated with respect to time based on temporal data obtained by a time measuring unit such as a timer (not shown), so as to calculate the velocity of the communication device 1.

In step S208, the direction determination unit 103 determines whether the velocity calculated in step S207 is greater than a predetermined value V_{R}. If it is greater than the predetermined value V_{R}, the routine proceeds to step S212; if not, the routine proceeds to step S209.

In step S209, the direction determination unit 103 determines whether the velocity calculated in step S207 is less than a predetermined value V_{S}. If it is less than the predetermined value V_{S}, the routine proceeds to step S211; if not, it proceeds to step S210.

Steps S210 to S212 are identical to steps S109 to S111 of FIG. 6; therefore, their description is omitted.

Through these steps, a communication direction between the communication device 1 and the communication device 2 is determined based on the velocity of the communication device 1 as it moves relative to the communication device 2, and then data transmission/reception is performed.

In accordance with the communication system, the communication method, or the communication device of Embodiment 1, a communication direction between different communication devices is determined by the operator moving his communication device, and then data transmission/reception is performed. Thus, an intended command can be easily acquired from the movement of the operator and executed, and the operator can experience a natural and intuitive sense of operation.

### Embodiment 2

(A communication system in which a communication direction is determined by a change in angle)

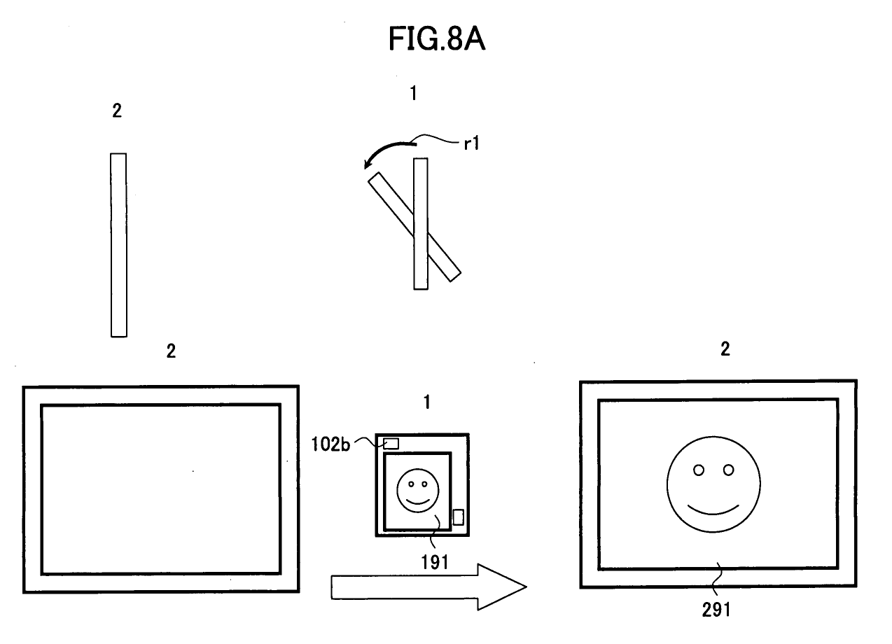

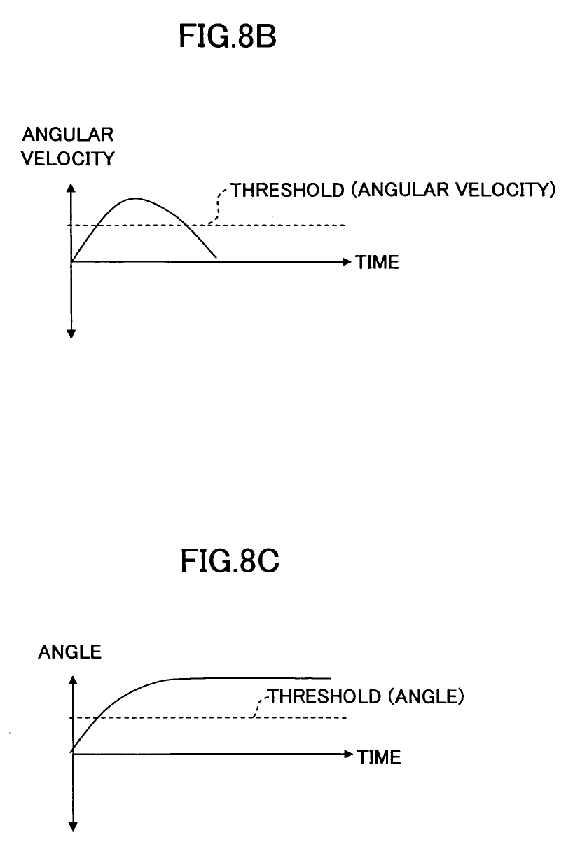

Referring to FIGS. 8A through 10, a communication system in which a communication direction is determined by a change in angle or angular velocity is described. FIG. 8A shows a configuration of the communication system of the present embodiment. The communication system comprises a communication device 1 and a communication device 2.

The communication device 1 includes an angular velocity detection unit 102b. The angular velocity detection unit 102b is mounted on the communication device 1 such that it can detect the angular velocity of the communication device 1 as it is rotated in the direction of arrow r1 as shown in the upper side of FIG. 8A. The angular velocity detection unit 102b may comprise an inexpensive piezoelectric vibrating gyro device used in video cameras, digital cameras, etc; for detecting and compensating for hand movement. Such a gyro device may be implemented on the internal circuit board of the communication device 1, for example.

In the lower side of FIG. 8A, the detection axis of the angular velocity detection unit 102b is perpendicular to the drawing sheet. Thus, when the communication device 1 is rotated in the direction of r1 about a central axis of the communication device 1, an angular velocity waveform as shown in FIG. 8B is obtained. By integrating the angular velocity of FIG. 8B, an angle can be determined as shown in FIG. 8C.

The detection of angular velocity by the angular velocity detection unit 102b may be initiated at the time of depressing the mode selection switch in the communication device 1; in this case, integration calculations are also started at the same time.

The thus acquired angular velocity data may be AC-coupled to reduce low-frequency fluctuations. Since such integrating calculations are subject to drift due to various noises, resulting in a gradual variation in the angle, the data may be passed through an HPF (high-pass filter) so as to remove frequency components lower than the frequency of the angular change caused by a gesture. Errors can be further reduced by, e.g., performing a process to reset the drift periodically.

With the communications between the communication device 1 and the communication device 2 established, the operator depresses a mode selection switch on the communication device 1, whereby the mode selection unit 104 selects the data transmission/reception mode.

Upon selection of the data transmission/reception mode, the angular velocity detection unit 102b is activated to detect angular velocity. The direction determination unit 103 then starts to monitor the output of the angular velocity detection unit 102b, i.e., a detected angular velocity, and determines whether the output angular velocity exceeds a predetermined value.

If the angular velocity exceeds the predetermined value, the direction determination unit 103 determines that transmission of data from the communication device 1 to the communication device 2 has been ordered, and relevant data transmission is performed by the communication unit 101. In the example of FIG. 8A, image data displayed on the display unit 191 of the communication device 1 are transmitted to the communication device 2 to be displayed on the display unit 291. A similar process of determination involving a predetermined value may be employed in the case where a change in angle is used instead of angular velocity.

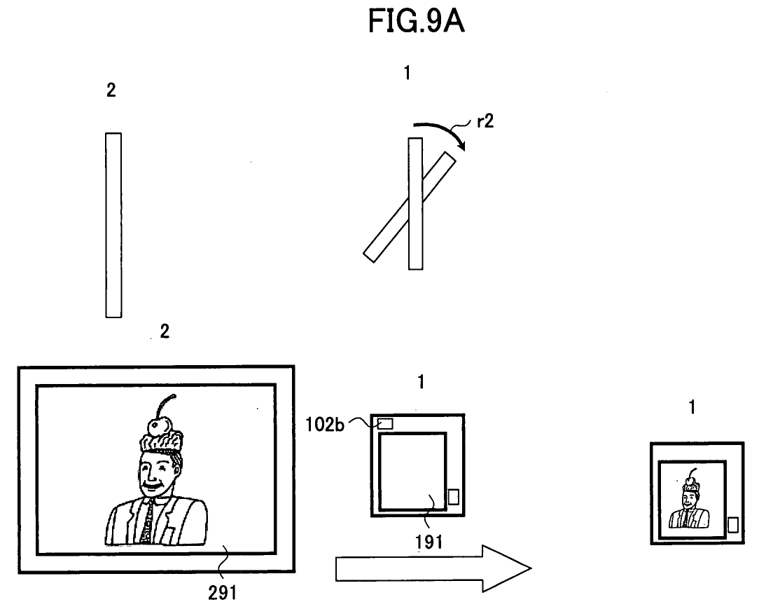

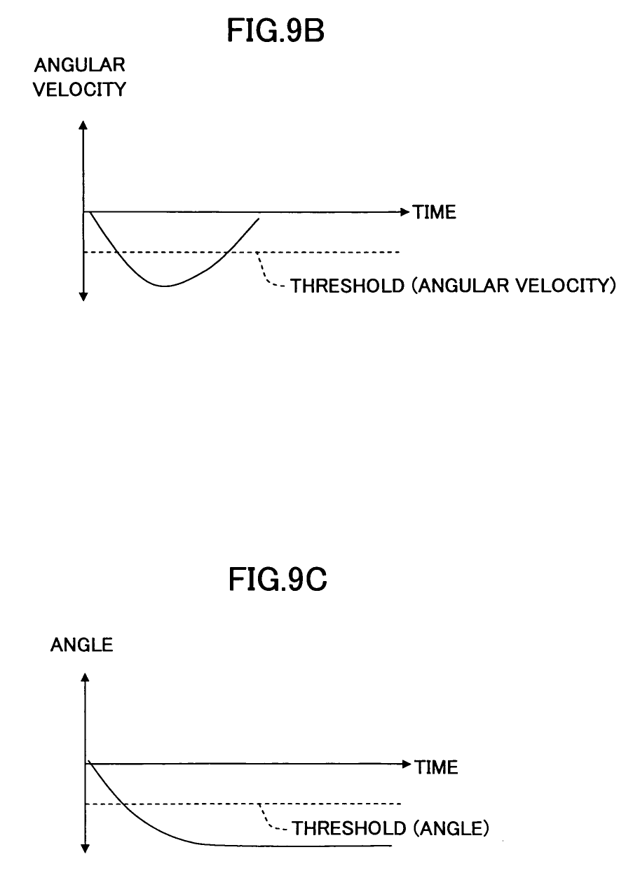

FIGS. 9A through 9C show another example in which the direction of rotation of the communication device 1 is different from FIG. 8. In FIG. 9A, as the communication device 1 is rotated about a central axis in the direction of arrow r2, an angular velocity in the negative direction is produced as shown in FIG. 9B. Based on such angular velocity, the direction determination unit 103 determines that data transmission from the communication device 2 to the communication device 1 has been ordered, and relevant data reception is performed by the communication unit 101.

For the determination of the communication direction, the angle according to FIG. 9C, which is obtained by integrating the angular velocity of FIG. 9B, may be used.

(Flowchart of an example of the process of determining a communication direction based on a change in angular velocity)

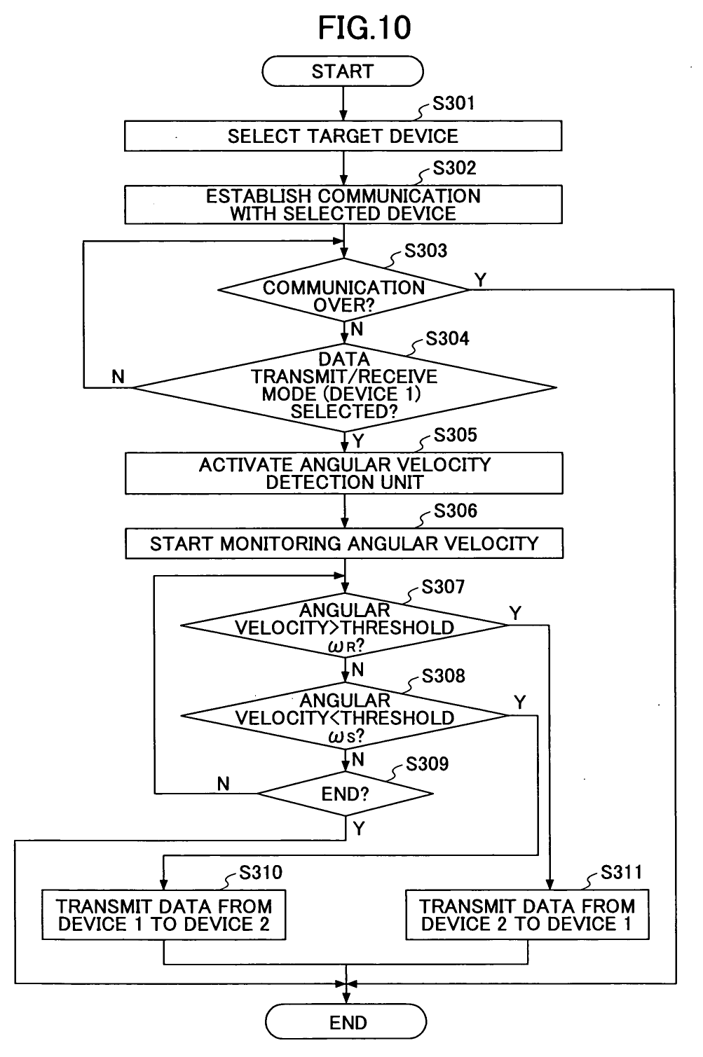

FIG. 10 shows a flowchart of an example of the process of determining a communication direction based on a change in angular velocity. Since steps S301 through S304 of FIG. 10 are identical to steps S101 through S104 of FIG. 6, their description is omitted.

In step S305, the angular velocity detection unit 102b, which is a physical quantity detection unit, is activated. In step S306, the angular velocity detection unit 102b detects an angular velocity of the communication device 1 as it rotates. The detection is continued for a predetermined period of time.

In step S307, the direction determination unit 103 determines whether the angular velocity detected by the angular velocity detection unit 102b has exceeded a predetermined value ω_{R}. If the predetermined value is exceeded, the routine proceeds to step S311; if not, the routine proceeds to step S308.

In step S308, the direction determination unit 103 determines whether the angular velocity detected by the angular velocity detection unit 102b has dropped below a predetermined value ω_{S}. If it has, the routine proceeds to step S310; if not, the routine proceeds to step S309.

Since steps S309 through S311 are identical to steps S109 through S111 of FIG. 6, their description is herein omitted.

Thus, in accordance with the present embodiment, a change in a physical quantity caused by the movement of one communication device can be detected by its own physical quantity detection unit, so that the structure of the communication system can be simplified.

### Embodiment 3

(A communication system in which a communication direction is determined based on a change in acceleration)

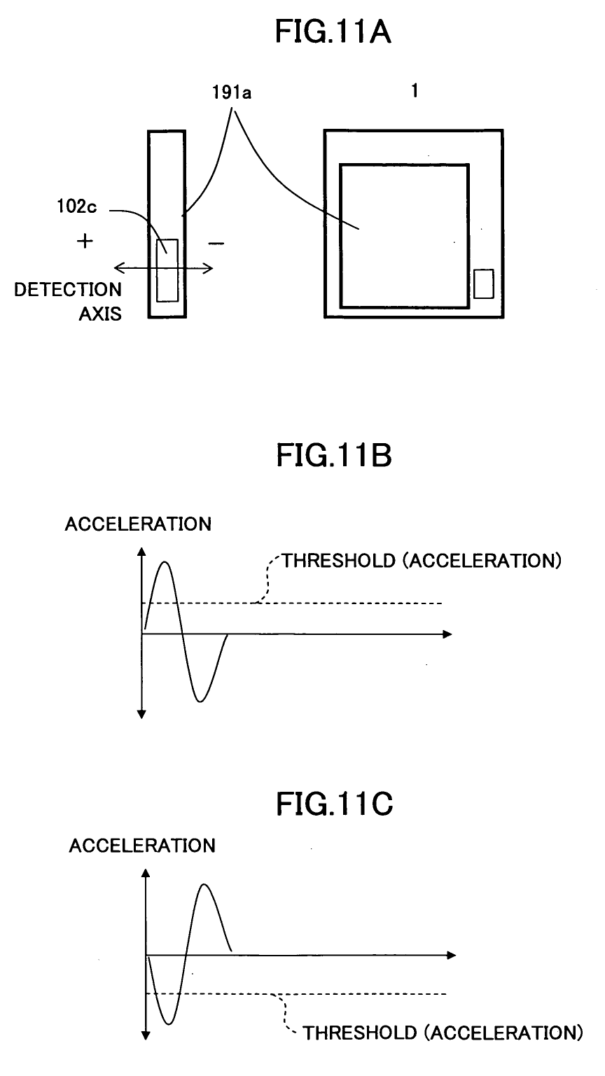

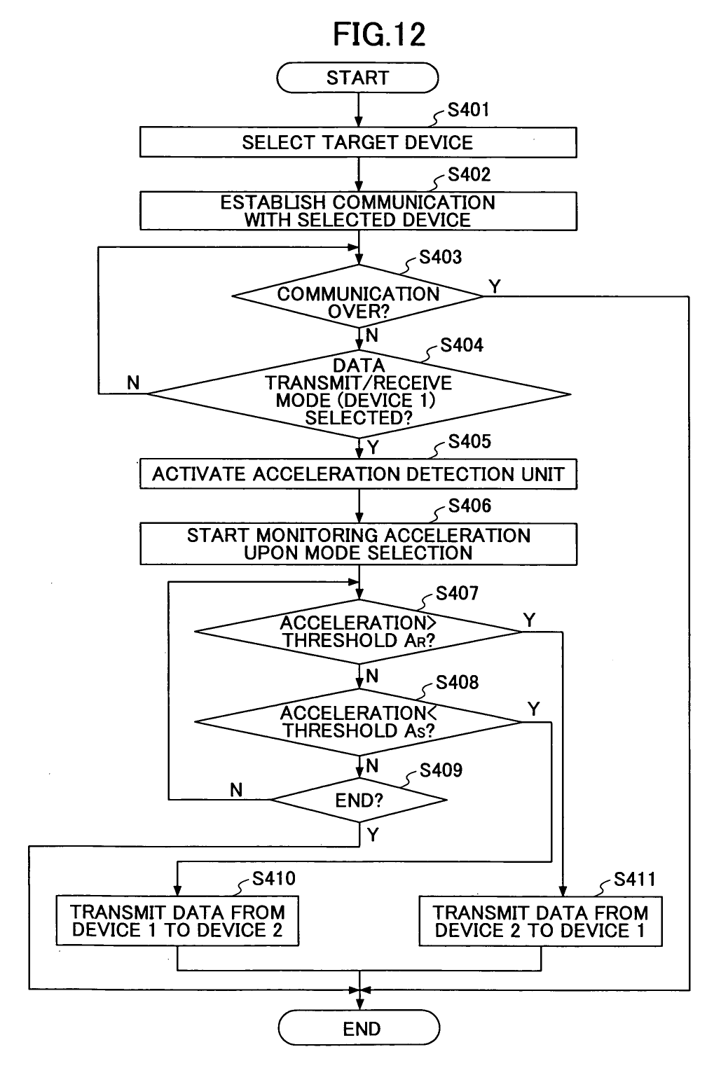

With reference to FIGS. 11A through 12, a communication system in which a communication direction is determined based on a change in acceleration is described. Referring to FIG. 11A, the communication device 1 comprises an acceleration sensor 102c as a physical quantity detection unit. The acceleration sensor 102c is mounted such that its detection axis is perpendicular to the display surface 191a of the display unit of the communication device 1. In this way, the polarity of acceleration in a direction perpendicular to the display surface 191a can be detected. In FIG. 11A, the front surface of the display surface 191a is assumed to be toward the positive direction while the back surface of the display surface 191a is assumed to be toward the negative direction.

Any of various types of acceleration sensors 102c may be used, such as a piezoresistive type, capacitive type, and piezoelectric type. Preferably, a piezoelectric type of acceleration sensor is used, which has no sensitivity to DC components and is not readily influenced by the acceleration of gravity, whereby the process of detecting the operator's gesture can be simplified.

The oscillating component detected in FIG. 11A is subjected to a threshold process. Specifically, if the oscillation component becomes greater than a first predetermined value as shown in FIG. 11B, data transmission is performed from the communication device 1 to the communication device 2. If the oscillation component becomes smaller than a second predetermined value as shown in FIG. 11C, data transmission is performed from the communication device 1 to the communication device 2.

FIG. 12 shows a flowchart of an example of the process of determining a communication direction based on a change in acceleration in the communication system of FIGS. 11A through 11C. The flowchart of FIG. 12 is identical to the flowchart of FIG. 10 with the exception that the angular velocity detection unit 102b is replaced by an acceleration detection unit 102c, and angular velocity as a detected physical quantity is replaced by acceleration. Thus, the description of the flowchart of FIG. 12 is omitted.

In accordance with the present embodiment, as in Embodiment 2, a change in a physical quantity caused by the movement of one communication device can be detected by its own physical quantity detection unit, so that the structure of the communication system can be simplified.

### Embodiment 4

(An example of a process of selecting a function of a communication device)

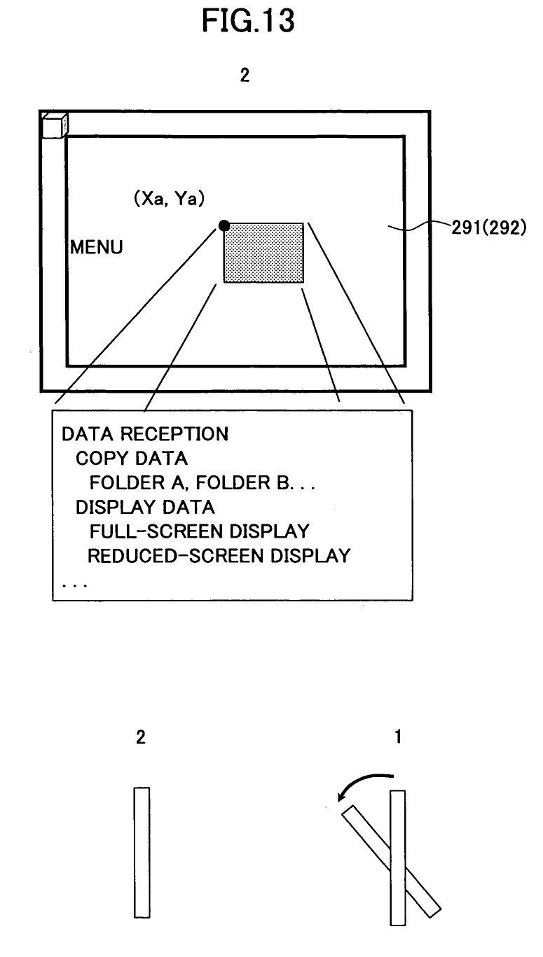

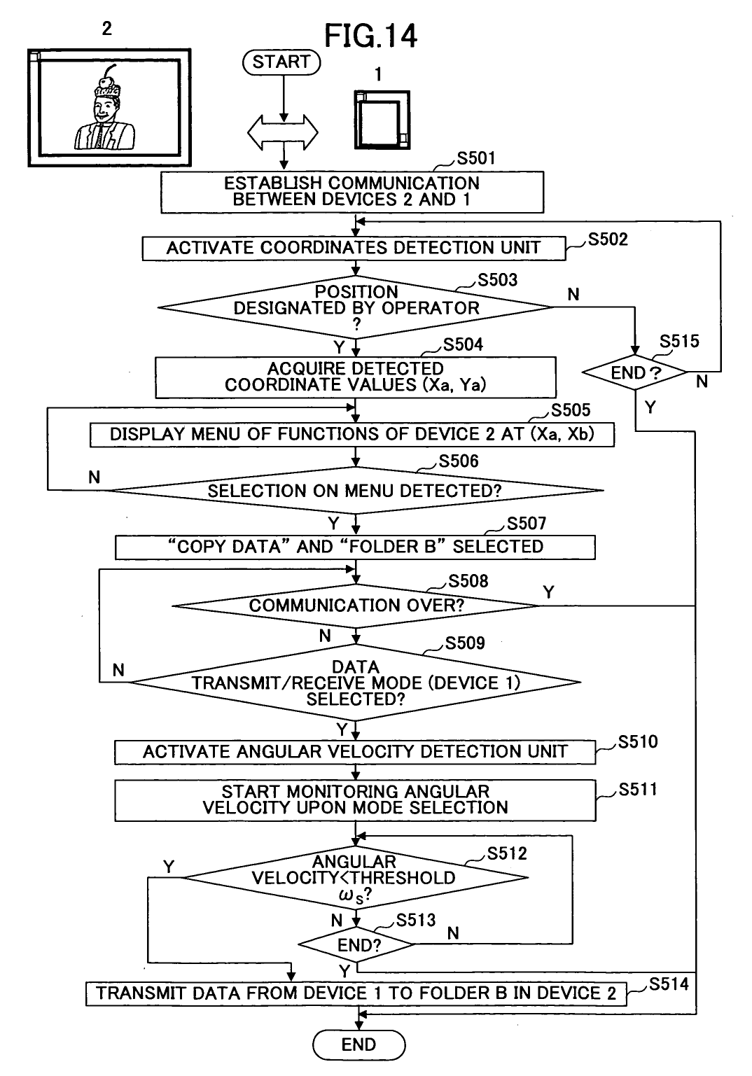

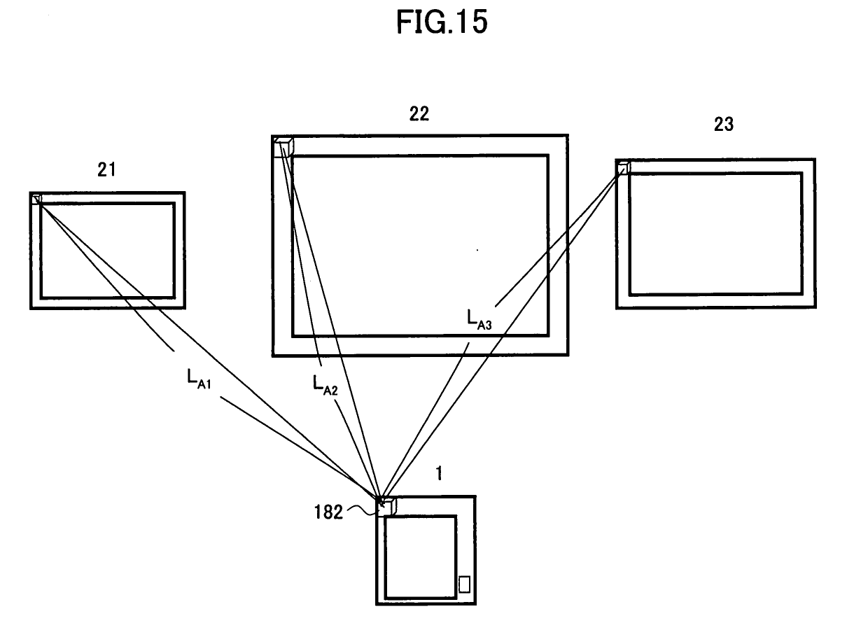

With reference to FIGS. 13 and 14, an example of a process of selecting and performing a function of the communication device 2 is described. In FIG. 13, the physical quantity detection unit included in the communication device 1 and the communication device 2 may be configured to detect distance, velocity, angular velocity, or acceleration.

In FIGS. 13 and 14, the display unit 291 of the communication device 2 is combined with the input unit 292 in a single touch panel device. Thus, an operator can designate a desired position on the touch panel by touching its screen with a finger or a pen, for example.

Referring to FIG. 13, the coordinates (Xa, Ya) of a position on the display unit 291 touched by the operator are acquired by a coordinate indicating unit (not shown). In an area determined with respect to the coordinates (Xa, Ya), information about the functions and the like of the communication device 2 is displayed. In the illustrated example in FIG. 13, a menu listing “Data reception,” “Copy data,” “Display data,” etc., is displayed.

While in FIG. 13 the location of the menu is determined with respect to where the display unit 291 of the communication device 2 is touched by the operator, this is merely an example. In another example, the operator may move the communication device 1 in a predetermined operation, whereby the physical quantity detection unit 102 of the communication device 1 may detect a change in a physical quantity based on that movement. Then, an instruction corresponding to such change may be transmitted to the communication device 2 so as to cause the functions and the like of the communication device 2 to be displayed.

The coordinates (Xa, Ya), with reference to which the menu is located, may be located at other than the upper-left corner of the rectangular area as shown in FIG. 13. For example, the coordinates may be located at the upper-right, lower-left, lower-right, or in the middle of one of the sides of the rectangle. The shape of the menu display area is not limited to the rectangular one as shown.

As an alternative to the above example where the display position for the information about the functions of the communication device 2 is determined by the indicated coordinates, a display position and the size of display may be determined in advance, so that a menu or the like can be displayed at the predetermined position and with the predetermined size upon detection of an operation on the touch panel.

FIG. 14 shows a flowchart of an example of the process of causing plural functions of the communication device 2 to be displayed, selecting one of the functions, and performing it.

In step S501, communications between the communication device 1 and the communication device 2 are established by the communication establishing unit 105 and the communication establishing unit 205. In step S502, a coordinate detection unit (not shown) of the communication device 2 is activated to perform the coordinates detection process. In the case where the display unit 291 comprises a touch panel, the coordinates of a position on the touch panel touched by the operator can be detected. In another embodiment, the display unit 291 may not have a touch panel. In this case, a position on the screen of the display unit 291 may be designated via the input unit 292 provided separately from the display unit 291, for example.

Thereafter, in step S503, the coordinate detection unit determines whether a display position has been designated by the operator. Namely, it is determined whether, in the case of a touch panel, the touch panel has been touched. In the case of a pointing device, such as a mouse, it is determined whether an input has been entered via the device. If a display position has been designated, the routine proceeds to step S504; if not, the routine proceeds to step S515.

In step S504, the coordinate detection unit acquires the coordinates (Xa, Ya) designating the display position entered by the operator in step S503. In step S505, the screen generation unit 260 generates a screen for information about the functions of the communication device 2. The screen is then displayed by the unit 291.

In step S506, it is determined whether a selection has been entered by the operator based on the screen displayed in step S505 showing the information about the functions of the communication device 2. If a selection has been entered, the routine proceeds to step S507; if not, the routine returns to step S505.

In step S507, the operator enters, via the touch panel, the selection of “Copy data” from the functions of the communication device 2 and the selection of “Folder B” as a copy destination folder.

In step S508, it is determined whether data transmission/reception has been completed. If data transmission/reception has been completed, a step is carried out to end the communications between the communication unit 101 and the communication unit 201. If not, the routine proceeds to step S509.

In step S509, the mode selection unit 104 determines whether the data transmission/reception mode has been selected by the operator depressing a mode selection switch, for example. If the data transmission/reception mode has been selected, the routine proceeds to step S510; if not, the routine returns to step S508. Instead of selecting the data transmission/reception mode, a mode to detect a change in the distance as a physical quantity may be selected.

In step S510, in response to the setting of the data transmission/reception mode or the physical quantity detection mode by the mode selection unit 104, the physical quantity detection unit 102 is activated. It is noted that in the example of FIG. 14, the physical quantity detection unit comprises the angular velocity detection unit 102b. In step S511, the angular velocity detection unit 102b detects the angular velocity of the communication device 1 as it rotates. This detection is continued for a predetermined period of time.

In step S512, the direction determination unit 103 determines whether the angular velocity detected by the angular velocity detection unit 102b has become less than a predetermined value ω_{S}. If it has become less than the predetermined value, the routine proceeds to step S514; if not, the routine proceeds to step S513.

In step S513, the mode selection unit 104 determines whether the data transmission/reception mode or the physical quantity detection mode should be ended. If “Yes,” either mode is ended; if “No,” the routine returns to step S512. The decision as to whether the data transmission/reception mode or the physical quantity detection mode should be ended may be based on the entry by the operator of an instruction to end either mode via the input unit 192. Alternatively, the determination may be based on the passage of a predetermined period of time following the selection of either mode.

In the example of FIG. 14, a communication direction is selected by the operator in step S507. Thus, in steps S511 through S513, it is determined whether the angular velocity has dropped below the predetermined value ω_{S} and no determination is made as to whether the angular velocity has exceeded the predetermined value ω_{R}.

In step S514, data are transmitted from the communication device 1 to the communication device 2, where the data are stored in “Folder B.”

Through these steps, data selected by the operator are transmitted from the communication device 1 to the communication device 2, where the data are stored in a selected folder.

While the embodiment shown in FIGS. 13 and 14 involves the transfer of a file, the present invention is not limited to such an embodiment. In another embodiment, when the communication device 2 includes an image forming function, an operator may enter conditions concerning image formation via the input unit 292 of the communication device 2. In this case, when the communication device 1 is moved toward the communication device 2, data retained in the communication device 1 can be output via the image formation unit 275 of the communication device 2.

In another embodiment, when the communication device 2 includes a facsimile function, an operator may move the communication device 1 closer after entering a facsimile number via the input unit 292, so that data retained in the communication device 1 can be transmitted to the communication device 2 from which the data can be further transmitted by facsimile communication.

While in the embodiment of FIGS. 13 and 14 the screen for showing the information about the functions of the communication device 2 is displayed by the display unit 291 of the communication device 2, the present invention is not limited to such an embodiment. In another embodiment, the information about the functions of the communication device 2 may be transmitted to the communication device 1 and displayed by the display unit 191 of the communication device 1. In this case, the operator selects a function via the input unit 192 of the communication device 1. In this way, the operator need only operate one communication device, whereby an operator-friendly environment can be provided.

In accordance with the present embodiment, based on the detection of a change in a physical quantity caused by the movement of the communication device 1, an instruction to perform a function of the communication device 2 is acquired and transmitted to the communication device 2. Thereby, not only an instruction concerning a data communication direction but also an instruction concerning a process to be performed after data transmission or reception can be acquired and transmitted. Thus, a job intended by the operator can be realized based on the movement of the operator.

### Embodiment 5

(Process of determining a communication device to communicate with based on the distance from plural communication devices)

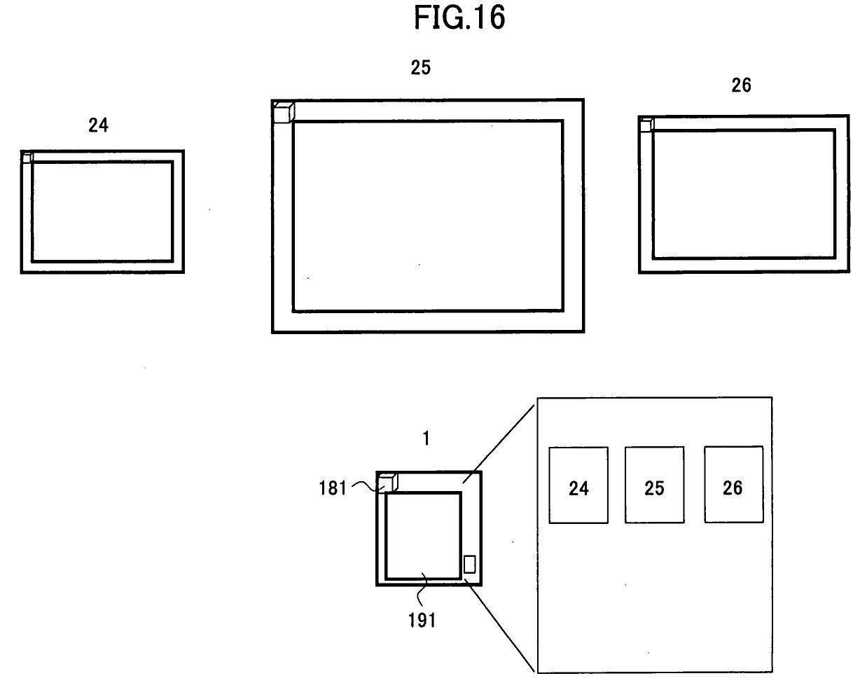

With reference to FIG. 15, a process of determining a communication device to communicate with based on the distance from plural different communication devices is described. FIG. 15 shows communication devices 21 to 23 as candidates for communication with the communication device 1. The communication devices 21 to 23 are all capable of communicating with the communication device 1.

The communication device 1 acquires distances L_{A1} through L_{A3} from the communication devices 21 through 23, using the distance measuring unit 182. The communication device 22 having the shortest distance, i.e., L_{A2}, is selected as the counterpart communication device, and communications with that communication device are established by the communication establishing unit 105.

The measurement of the distance between the communication device 1 and each of the communication devices 21 through 23 may be performed either simultaneously or successively. In a case where the distance measurement is performed simultaneously by a distance measuring unit using a single physical medium, such as airborne ultrasound, the distance measurement might be hindered by an instability factor such as interference. In such a case, corrections can be made by using different physical media among the individual devices, for example.

“To use different physical media” means combining, airborne ultrasound, light, etc. Such combinations require multiple sensors or transducers, resulting in a complex structure. On the other hand, it provides an advantage that communication with a desired device can be established within a short period of time.

In the case of successive distance measurement, the structure can be simplified because of the use of the same medium in chronological order; however, this takes a longer measurement time. Thus, the simultaneous and successive distance measurement methods have their own advantages and disadvantages, and should be selected in view of system requirements.

For the identification of each device, information identifying each device is superposed by modulating ultrasound or an optical signal that is transmitted or received upon distance detection. Alternatively, such identifying information may be transmitted by a separately provided radio or optical data transmission unit. In this way, communications can be established by the operator moving his device closer to another device with which he wishes to communicate. Thus, the communication device 1 can acquire an instruction from the operator as he intends while enabling the operator to experience a natural sense of operation.

(Process of determining a communication device to communicate with based on angle relative to plural different communication devices)

With reference to FIG. 16, a process of determining a communication device to communicate with based on an angle relative to each of plural communication devices is described. FIG. 16 shows a communication device 1 which includes an opposed angle measuring unit 181. The opposed angle measuring unit 181 measures the opposed angle of the communication devices 24 through 26 relative to the communication device 1 so as to determine a device that the communication device 1 is to communicate with. The opposed angle measuring unit 181 comprises a unit for measuring an azimuth, such as a geomagnetic sensor. It detects relative angles of the individual communication devices 24 through 26 so that communications can be established with one of them that is more directly opposite from the communication device 1.

In addition to the opposed angle measuring unit, a triaxial acceleration sensor may be provided in the communication device 1 and in the communication devices 24 through 26, so that geomagnetic sensor signals can be corrected from the direction in which each communication device is installed. Alternatively, the relative angle of each communication device may be detected by providing each communication device with multiple distance detection units, such as airborne ultrasound sensors and laser displacement sensors, thus enabling distance measurement at multiple locations of each communication device.

In another embodiment, the relative position of each communication device may be detected by a position detection unit (not shown) and displayed on the display unit 191 of the communication device 1. In this way, the operator can select a counterpart communication device based on the displayed relative positions before establishing communications.

Such a position detection unit does not need to be capable of measuring a precise position of each device; it only needs to be capable of detecting the arrangement of the individual information devices. Thus, in another embodiment, the communication devices 24 through 26 may each have affixed a medium having ID information in the form of, e.g., a barcode. The communication device 1 may be provided with an imaging unit configured to produce an image in which all three of the communication devices 24 through 26 are included, so that their positional relationships can be ascertained by image recognition.

Further alternatively, the position detection unit may be configured to detect the positional relationship of the devices by triangulation using plural ultrasound sensors.

Thus, by generating a screen for displaying the relative positions that have been acquired of the communication devices using the candidate screen generation unit 162 of the communication device 1 and displaying the screen as shown in FIG. 16, it becomes easier for an operator to select a counterpart communication device. The selection by the operator may be entered via a touch panel, switches, etc.

Preferably, the screen of the communication device 1 shown in FIG. 16 shows the positions of the communication devices 24 through 26 relative to the communication device 1 in a manner substantially identical to their actual relative positions. In this way, the relative positions of communication devices can be shown to the operator in a more useful manner.

Thus, in accordance with the embodiment of FIG. 16, communications are established by the operator facing his communication device 1 opposite a communication device with which communication is desired.

In accordance with the embodiments shown in FIGS. 15 and 16, when there are plural communication device candidates, an operator can select one of the candidates easily. Furthermore, since the communication device 1 is configured to measure its distance or the like from other communication devices as the operator moves the communication device 1, the user's selection of a communication device is facilitated.

(Implementation with a computer or the like)

In an embodiment of the present invention, a communication device is realized with a personal computer in which the operations and processes described with reference to the foregoing embodiments are performed or processed by a CPU in accordance with a program saved in a ROM or a hard disk unit, using a main memory such as a RAM as a work area.

While the present invention has been described in the foregoing with reference to preferred embodiments thereof, the present invention is not limited to such embodiments, and various changes and modifications may occur to those skilled in the art without departing from the scope of the present invention.

The present application is based on the Japanese Priority Application No. 2007-057885 filed Mar. 7, 2007, the entire contents of which are hereby incorporated by reference.

What is claimed is:

1. A communication system comprising a first communication device and a second communication device that communicate with each other,
the first communication device comprising:
a physical quantity detection unit configured to detect a physical quantity that changes as the first communication device moves;
a direction determination unit configured to determine a communication direction between the first and second communication devices in accordance with a change in the physical quantity detected by the physical quantity detection unit; and
a communication unit configured to communicate with the second communication device based on the communication direction that is determined by the direction determination unit.

2. The communication system according to claim 1, wherein the second communication device comprises a physical quantity detection slave unit corresponding to the physical quantity detection unit, wherein the physical quantity detection unit is configured to detect the physical quantity in cooperation with the physical quantity detection slave unit.

3. The communication system according to claim 1, wherein the direction determination unit is configured to determine the communication direction based on the change in the physical quantity detected by the physical quantity detection unit exceeding a predetermined value.

4. The communication system according to claim 1, wherein the first communication device comprises a mode selection unit configured to select a data transmission/reception mode,
wherein the direction determination unit is configured to determine the communication direction based on the change in the physical quantity upon selection of the data transmission/reception mode.

5. The communication system according to claim 1, wherein the first communication device comprises a distance measuring unit configured to measure the distance from the second communication device,
wherein the communication unit is configured to communicate with one of plural different candidates for the second communication device which one has the shortest distance from the first communication device.

6. The communication system according to claim 1, wherein the first communication device comprises an opposed angle measuring unit configured to measure an opposed angle of the second communication device relative to the first communication device,
wherein the communication unit is configured to communicate with one of plural different candidates for the second communication device which one has the smallest opposed angle.

7. The communication system according to claim 1, wherein the first communication device further comprises:
a screen generation unit configured to generate a screen for displaying information about the functions of the second communication device; and
a function selection unit configured to select one of the functions of the second communication device;
wherein the second communication device is configured to transmit data received from the first communication device in accordance with the function selected by the function selection unit, or to transmit received data to the first communication device in accordance with the function selected by the function selection unit.

8. The communication system according to claim 1, wherein the first communication device further comprises:
a candidate information acquisition unit configured to acquire information about candidates for the second communication device; and
a candidate screen generation unit configured to generate a screen for displaying information about the candidates for the second communication device.

9. A communication method for a communication system in which a first communication device and a second communication device communicate with each other, the method comprising the steps of:
the first communication device detecting a physical quantity that changes as the first communication device moves;
the first communication device determining a communication direction between the first and second communication devices based on a change in the physical quantity detected by the physical quantity detection step; and
initiating communications between the first communication device and the second communication device based on the communication direction that has been determined.

10. The communication method according to claim 9, wherein the communication direction determining step comprises determining the communication direction based on the change in the physical quantity detected in the physical quantity detection step exceeding a predetermined value.

11. The communication method according to claim 9, further comprising the step of the first communication device selecting a data transmission/reception mode,
wherein the communication direction determining step comprises determining the communication direction based on the change in the physical quantity upon selection of the data transmission/reception mode.

12. A communication device configured to communicate with another communication device, comprising:
a physical quantity detection unit configured to detect a physical quantity that changes as the communication device moves;
a direction determination unit configured to determine a communication direction based on a change in the physical quantity detected by the physical quantity detection unit; and
a communication unit configured to communicate with the other communication device based on the communication direction that is determined by the direction determination unit.

13. The communication device according to claim 12, wherein the direction determination unit is configured to determine the communication direction for transmission when the change in the physical quantity indicates that the distance between the communication device and the other communication device is becoming shorter, and the communication direction for reception when the change in the physical quantity indicates that the distance between the communication device and the other communication device is becoming longer.
